(19) United States
(12) Patent Application Publication
(10) Pub. No.: US 2025/0297102 A1
(43) Pub. Date: Sep. 25, 2025

(54) URETHANE FOAM MOLDED BODY

(71) Applicant: Sumitomo Riko Company Limited, Aichi (JP)

(72) Inventor: Takahisa Kose, Aichi (JP)

(73) Assignee: Sumitomo Riko Company Limited, Aichi (JP)

(21) Appl. No.: 19/231,564

(22) Filed: Jun. 9, 2025

Related U.S. Application Data
(63) Continuation of application No. PCT/JP2023/046983, filed on Dec. 27, 2023.

(30) Foreign Application Priority Data
Mar. 31, 2023 (JP) 2023-057017

(51) Int. Cl. C08L 75/04; C08K 3/04; C08K 3/11; C08K 3/34; C08K 9/08

(52) U.S. Cl. CPC C08L 75/04; C08K 3/04; C08K 3/11; C08K 3/34; C08K 9/08; C08K 2201/001; C08K 2201/005; C08L 2201/02; C08L 2203/14

(57) ABSTRACT

A urethane foam molded body is provided, which includes a base material made of polyurethane foam, and composite particles oriented and contained in the base material. The composite particles include: a first composite particle having an expanded graphite particle and a magnetic particle adhered to a surface of the expanded graphite particle by a binder; and a second composite particle having an expandable graphite particle and a magnetic particle adhered to a surface of the expandable graphite particle by a binder. In the urethane foam molded body, when a total mass of the expanded graphite particle and the expandable graphite particle in the base material is 100 mass %, a content of the expanded graphite particle is 20 mass % or more and 80 mass % or less.

### CROSS-REFERENCE TO RELATED APPLICATION

The present application is a continuation of PCT/JP2023/046983, filed on Dec. 27, 2023, and is related to and claims priority from Japanese patent application no. 2023-057017, filed on Mar. 31, 2023. The entire contents of the aforementioned application are hereby incorporated by reference herein.

### BACKGROUND

### Technical Field

The disclosure relates to a urethane foam molded body having high thermal conductivity.

### Related Art

In vehicles such as automobiles, measures are taken to reduce noise generated from engines, transmissions, and the like in order to reduce noise leaking to the outside of the vehicle or into the passenger compartment. In electric vehicles (EVs) and hybrid electric vehicles (HEVs), driving sounds from electric powertrains consisting of inverters, motors, gear boxes, and the like are also targets for reduction. As a noise countermeasure, for example, soundproofing materials made of foam such as polyurethane foam are used. Foam has a low thermal conductivity coefficient because it has numerous cells (bubbles) inside. Thus, when placed around a noise source that generates heat, there is a risk of malfunction due to heat accumulation.

From the viewpoint of improving heat dissipation of soundproofing materials using foam, for example, Patent Literature 1 (International Publication No. 2013/042611) describes a urethane foam molded body with improved heat dissipation by forming a heat transmission path in the orientation direction by orienting and arranging composite particles in which thermally conductive particles, magnetic particles, and insulating inorganic particles are composited in polyurethane foam. Expandable graphite and the like are described as the thermally conductive particles. Patent Literature 2 (Japanese Patent Application Laid-Open Publication No. 2022-72896) describes a polyurethane foam containing thermally conductive fillers. Expandable graphite, expanded graphite, and the like are described as the thermally conductive fillers.

Depending on the application, flame retardancy is also required in addition to thermal conductivity for soundproofing materials. For example, polyurethane foam with flame retardancy has a dropping effect that suppresses the spread of fire by dropping burning material when exposed to flames. In the urethane foam molded body described in Patent Literature 1, composite particles made by adhering magnetic particles to the surface of particles with relatively high thermal conductivity (thermally conductive particles) are used to orient these particles. When magnetic particles are blended into polyurethane foam, there is a risk that the dropping effect may be impaired and self-extinguishing properties may decrease. Thus, in consideration of flame retardancy, expandable graphite, which has a flame retardant effect due to a substance inserted between layers of flaky graphite that generates gas upon heating, is preferable as the thermally conductive particle. In this way, the flame retardancy of the urethane foam molded body is improved by using expandable graphite as the thermally conductive particle in the composite particles. However, in recent years, higher thermal conductivity is required for soundproofing materials. In this case, the thermal conductivity coefficient of expandable graphite cannot be said to be sufficiently high, and there is a limit to the improvement of thermal conductivity by using expandable graphite alone.

In this regard, according to Patent Literature 2, expandable graphite and expanded graphite are mentioned as thermally conductive fillers. Expanded graphite is manufactured by heating expandable graphite to expand it and then pulverizing it, and it has high purity because the interlayer substance has disappeared. Thus, the thermal conductivity coefficient of expanded graphite is greater than that of expandable graphite. However, in Patent Literature 2, as described in paragraph [0006], the purpose is to perform foam molding without applying a magnetic field. Thus, the thermally conductive fillers in the polyurethane foam are not oriented, and even if expandable graphite or expanded graphite is used as the thermally conductive filler, these are merely dispersed individually. According to the investigation by the inventors of the disclosure, it has been found that merely dispersing expanded graphite in polyurethane foam results in a small improvement effect in thermal conductivity.

The disclosure provides a urethane foam molded body with excellent thermal conductivity and flame retardancy.

### SUMMARY

(1) The urethane foam molded body of the disclosure includes: a base material made of polyurethane foam, and composite particles oriented and contained in the base material, in which the composite particles include: a first composite particle having an expanded graphite particle and a magnetic particle adhered to a surface of the expanded graphite particle by a binder; and a second composite particle having an expandable graphite particle and a magnetic particle adhered to a surface of the expandable graphite particle by a binder, and when a total mass of the expanded graphite particle and the expandable graphite particle in the base material is 100 mass %, a content of the expanded graphite particle is 20 mass % or more and 80 mass % or less.

The urethane foam molded body of the disclosure has at least two types of composite particles: first and second. In both composite particles, magnetic particles are adhered to the surface of the particles that become the core by a binder. The core particle of the first composite particle is an expanded graphite particle with a higher thermal conductivity coefficient than the expandable graphite particle, and mainly contributes to improving the thermal conductivity coefficient of the urethane foam molded body. The core particle of the second composite particle is an expandable graphite particle that exhibits a flame retardant effect, and mainly contributes to improving the flame retardancy of the urethane foam molded body. These composite particles are oriented in the base material made of polyurethane foam. By the composite particles being connected and oriented, a heat transmission path is formed in the base material. This makes it easier for heat to be transmitted to the composite particles, and compared to a form in which expanded graphite particles and expandable graphite particles are each contained individually, their respective effects are more easily exhibited. Further, both expanded graphite particles and expandable graphite particles are graphite-based materials with thermal conductivity anisotropy and high affinity with polyurethane.

The urethane foam molded body of the disclosure contains expanded graphite particles and expandable graphite particles, which have different functions, as separate independent composite particles. This allows each effect to be fully exhibited without interfering with each other's function. As a result, the desired thermal conductivity and flame retardancy may be achieved. However, in the urethane foam molded body of the disclosure, a form including composite particles in which magnetic particles are adhered to the surface of particles where expanded graphite particles and expandable graphite particles are integrated is not excluded.
(2) In the above configuration, the expanded graphite particle may have an average particle diameter of 100 μm or more and 3000 μm or less. According to this configuration, the effect of improving thermal conductivity by the expanded graphite particle may be exhibited while minimizing the impact on the moldability and brittleness of the urethane foam molded body.
(3) In any of the above configurations, the expanded graphite particle may have a purity of 99% or more. According to this configuration, the effect of improving thermal conductivity may be enhanced.
(4) In any of the above configurations, the expandable graphite particle may have an average particle diameter of 100 μm or more and 3000 μm or less. According to this configuration, the flame retardant effect by the expandable graphite particle may be exhibited while minimizing the impact on the moldability and brittleness of the urethane foam molded body.
(5) In any of the above configurations, the composite particles may have a content of 5 volume % or more and 50 volume % or less when a volume of urethane foam molded body is 100 volume %. According to this configuration, it is suitable for achieving both the moldability of the urethane foam molded body and the improvement of thermal conductivity coefficient and flame retardancy.
(6) In any of the above configurations, the binder constituting the first composite particle and the second composite particle may be a water-soluble polymer, According to this configuration, when manufacturing the urethane foam molded body, there is little impact on foam molding, and the burden on the environment is also small.
(7) In the configuration of (6) above, the water-soluble polymer may be one or more selected from methyl cellulose, carboxymethyl cellulose, hydroxypropyl methyl cellulose, polyvinyl alcohol, and starch. The water-soluble polymer of this configuration has good adhesiveness and is relatively inexpensive and easily available.
(8) In any of the above configurations, the magnetic particle constituting the first composite particle and the second composite particle may have a content of 20 mass % or more and 80 mass % or less when a total mass of the expanded graphite particle and the expandable graphite particle in the base material is 100 mass %. According to this configuration, since the amount of magnetic particle is relatively small, cost reduction and weight reduction may be achieved.
(9) In any of the above configurations, the magnetic particle constituting the first composite particle and the second composite particle may have one or more selected from an iron particle and an iron-based alloy particle. Iron particle and iron-based alloy particle have high saturation magnetization and are easily available as fine particles.
(10) In any of the above configurations, at least one of the first composite particle and the second composite particle may have an insulating inorganic particle adhered to a surface of the expanded graphite particle or the expandable graphite particle by a binder.

In this configuration, the insulating inorganic particle may be directly adhered to the surface of the expanded graphite particle or the expandable graphite particle that serves as the core, or may be indirectly adhered through the magnetic particle, that is, adhered to the surface of the magnetic particle that is adhered to each particle. As the magnetic particle, ferromagnetic materials such as stainless steel and iron are used. Thus, the composite particles in which the expanded graphite particle or the expandable graphite particle is composited with the magnetic particle has high conductivity. When the insulating inorganic particle is adhered to the composite particles in this state, even if the composite particles are oriented in contact with each other, it becomes difficult for the core particles or magnetic particles (conductive particles) to contact each other between adjacent composite particles. Thus, the electrical resistance between the composite particles increases. Further, by having the composite particles contact each other through the insulating inorganic particle, the electrical conduction between the composite particles may be interrupted. As a result, electrical insulation may be realized in the urethane foam molded body of this disclosure. Thus, according to this configuration, in addition to high thermal conductivity and flame retardancy, electrical insulation may also be imparted. Thus, the urethane foam molded body of this configuration is also suitable for applications where both heat dissipation and electrical insulation are required, such as heat dissipation components in electronic appliances.
(11) In the configuration of (10) above, the insulating inorganic particle may have one or more selected from aluminum hydroxide, aluminum oxide, magnesium hydroxide, magnesium oxide, talc, calcium carbonate, clay, mica, and silica. The insulating inorganic particle of this configuration has a relatively large thermal conductivity coefficient, so it is less likely to inhibit the thermal conductivity between composite particles. Further, it is relatively inexpensive and easily available.

In the urethane foam molded body of this disclosure, the expanded graphite particle and the expandable graphite particle are oriented and arranged in the base material as separate composite particles. Thus, the urethane foam molded body of this disclosure excels in thermal conductivity and flame retardancy.

### DESCRIPTION OF EMBODIMENTS

The following describes embodiments of the urethane foam molded body of this disclosure. It is noted that the embodiments are not limited to the following forms, and may be implemented in various modification examples and improvement forms that may be carried out by those skilled in the art.

### <Urethane Foam Molded Body>

The urethane foam molded body of this disclosure includes a base material made of polyurethane foam, and composite particles that are oriented and contained in the base material.

### [Base Material]

The polyurethane foam of the base material is manufactured from foamed urethane resin raw materials such as polyisocyanate components and polyol components. The foamed urethane resin raw materials may be prepared from already known raw materials such as polyols and polyisocyanates. As the polyol, polyhydroxy compounds, polyether polyols, polyester polyols, polymer polyols, polyether polyamines, polyester polyamines, alkylene polyols, urea dispersion polyols, melamine-modified polyols, polycarbonate polyols, acrylic polyols, polybutadiene polyols, phenol-modified polyols, etc. may be appropriately selected. As the polyisocyanate, for example, tolylene diisocyanate, phenylene diisocyanate, xylylene diisocyanate, diphenylmethane diisocyanate, triphenylmethane triisocyanate, polymethylene polyphenyl isocyanate, naphthalene diisocyanate, and derivatives thereof (for example, prepolymers obtained by reaction with polyols, modified polyisocyanates), etc. may be appropriately selected.

The foamed urethane resin raw materials may further be appropriately blended with catalysts, foaming agents, foam regulators, plasticizers, crosslinking agents, chain extenders, flame retardants, antistatic agents, viscosity reducers, stabilizers, fillers, colorants, etc. For example, as catalysts, amine-based catalysts such as tetraethylenediamine, triethylenediamine, dimethylethanolamine, and organometallic catalysts such as tin laurate, tin octanoate may be mentioned. As the foaming agent, water is preferable. Besides water, methylene chloride, freons, CO₂ gas, etc. may be mentioned. Further, as the foam regulator, silicone-based foam regulators are preferable, and as the crosslinking agent, triethanolamine, diethanolamine, etc. are preferable.

The shape, size, etc. of the base material are not particularly limited and may be appropriately determined according to the application. The composite particles contained in the base material may be arranged with a certain regularity. For example, the composite particles may be arranged in a straight line or in a curved line between one end and the other end of the urethane foam molded body (the other end does not have to be the end portion that is 180° opposite to one end). Also, the composite particles may be arranged radially from the center toward the periphery.

### [Composite Particles]

The composite particles that are oriented and contained in the base material are particles in which a magnetic particle and the like are adhered to the surface of a non-magnetic particle serving as a core with a binder, and include a first composite particle and a second composite particle. The first composite particle includes an expanded graphite particle and a magnetic particle adhered to the surface of the expanded graphite particle by a binder. The second composite particle includes an expandable graphite particle and a magnetic particle adhered to the surface of the expandable graphite particle by a binder. The non-magnetic particle serving as a core may be a single particle or a plurality of particles. For example, the expanded graphite particle constituting the first composite particle may be a single expanded graphite particle or an aggregate particle in which a plurality of expanded graphite particles are integrated. The expandable graphite particle constituting the second composite particle may be a single expandable graphite particle or an aggregate particle in which a plurality of expandable graphite particles are integrated. Further, the composite particles may include a particle in forms other than the first composite particle and the second composite particle, such as a form in which a magnetic particle is adhered to the surface of a particle in which an expanded graphite particle and an expandable graphite particles are integrated, or a form in which a magnetic particle is adhered to the surface of other graphite particles or metal particles.

The content of the composite particles may be determined considering thermal conductivity and flame retardancy, the effect on the foaming reaction of the polyurethane foam, moldability, and the like. To achieve the desired thermal conductivity and flame retardancy, it is desirable that the content of the composite particles is 5 volume % or more, and more preferably 10 volume % or more, when the volume of the urethane foam molded body is 100 volume %. On the other hand, from the viewpoint of not inhibiting the foaming reaction, it is desirable that the content of the composite particles is 50 volume % or less, and more preferably 20 volume % or less.

Further, when the total mass of the expanded graphite particles and the expandable graphite particles in the base material is 100 mass %, the content of the expanded graphite particle is set to 20 mass % or more and 80 mass % or less. If the content of the expanded graphite particle is less than 20 mass %, the improvement effect of thermal conductivity coefficient is small. 30 mass % or more is more preferable. Conversely, if the content of the expanded graphite particle exceeds 80 mass %, the flame retardancy decreases. 60 mass % or less is more preferable.

The expanded graphite particle constituting the first composite particle may be manufactured by heating and expanding expandable graphite, and then pulverizing the sheet-shaped molded product. The expanded graphite particle has a multilayer structure in which a plurality of graphenes are stacked. From the viewpoint of enhancing the improvement effect of thermal conductivity coefficient, the purity (content ratio of carbon component) of the expanded graphite particle is desirably 99% or more. The thermal conductivity coefficient of the expanded graphite particle is desirably 200 W/m·K or more.

The shape of the expanded graphite particle is not particularly limited and may be flake-shaped, fibrous, spherical, etc. From the viewpoint of increasing the thermal conductivity coefficient, the average particle diameter of the expanded graphite particle is desirably 100 μm or more, and more preferably 700 μm or more. On the other hand, if the expanded graphite particle is too large, there is a risk that the molded body may become brittle due to cracks originating therefrom. Thus, the average particle diameter of the expanded graphite particle is desirably 3000 μm or less, and more preferably 2000 μm or less. As for the average particle diameter in this specification, unless specifically stated otherwise, the median diameter (D₅₀) obtained from the volume-based particle size distribution measured by laser diffraction/scattering method is adopted. It is noted that for commercially available products, catalog values may be adopted.

The expandable graphite particle constituting the second composite particle is obtained by inserting a substance that generates gas upon heating between layers of flaky graphite by, for example, acid treatment. When heat is applied to the expandable graphite particle, the gas generated causes the interlayer spacing to widen, and a layer that is stable against heat and chemicals is formed. This stable layer becomes an insulating layer, providing a flame retardant effect by preventing heat transfer. For the expandable graphite particles, they may be appropriately selected considering the expansion start temperature, expansion ratio, etc. Since the expansion start temperature must be higher than the heat generation temperature during the molding of the urethane foam molded body, for example, expandable graphite particles with an expansion start temperature of 150° C. or higher are preferable.

The shape of the expandable graphite particle is not particularly limited and may be flake-shaped, fibrous, spherical, etc. Considering the dispersibility in polyurethane foam, the average particle diameter of the expandable graphite particle is desirably 100 μm or more, and more preferably 700 μm or more. On the other hand, similar to the case of the expanded graphite particle, if the expandable graphite particle is too large, there is a risk that the molded body may become brittle due to cracks originating therefrom. Thus, the average particle diameter of the expandable graphite particle is desirably 3000 μm or less, and more preferably 2000 μm or less. In the case where the size of the expandable graphite particle and the size of the expanded graphite particle are approximately the same, there are advantages such as being able to perform the granulation of composite particles together.

The magnetic particles adhered to the surface of the expanded graphite particle or the expandable graphite particle (which may be collectively referred to as “core particles” for either or both of these) that form the core in the first composite particle and the second composite particle may be the same or different. The magnetic particles may be any that may orient the composite particles, for example, particles of ferromagnetic materials such as iron, nickel, cobalt, gadolinium, stainless steel, magnetite, maghemite, manganese zinc ferrite, barium ferrite, strontium ferrite, etc., antiferromagnetic materials such as MnO, Cr₂O₃, FeCl₂, MnAs, etc., and alloys made using these are preferable. Among these, iron, nickel, cobalt, and their iron-based alloys (including stainless steel) are preferable from the viewpoint of being easily available as fine particles and having high saturation magnetization. In particular, iron is relatively inexpensive and easily available, making it possible to reduce manufacturing costs and suitable for mass production.

The magnetic particles may be directly adhered to the surface of the core particles, or may be indirectly adhered through other particles such as the insulating inorganic particles described later. Further, the magnetic particles may be adhered to only a part of the surface of the core particles, or may be adhered to cover the entire surface. The size of the magnetic particles may be appropriately determined in consideration of the size of the core particles, the orientability of the composite particles, and the thermal conductivity between composite particles. For example, the particle diameter of the magnetic particles is desirably 1/10 or less of the particle diameter of the core particles. As the size of the magnetic particles decreases, the saturation magnetization of the magnetic particles tends to decrease. Thus, in order to orient the composite particles with a smaller amount of magnetic particles, it is desirable that the average particle diameter of the magnetic particles be 100 nm or more, more preferably 1 μm or more, and even more preferably 5 μm or more.

The shape of the magnetic particles is not particularly limited. For example, in the case where the shape of the magnetic particles is flat, the distance between adjacent core particles becomes shorter compared to the case where they are spherical. This improves the thermal conductivity between adjacent composite particles. As a result, the thermal conductivity of the urethane foam molded body is improved. Further, in the case where the shape of the magnetic particles is flat, the magnetic particles and the core particles make contact over a surface. That is, the contact area between the two increases. This improves the adhesion between the magnetic particles and the core particles. Thus, the magnetic particles become less likely to peel off. In addition, the thermal conductivity between the magnetic particles and the core particles is also improved. For these reasons, it is desirable to adopt flake-shaped particles as the magnetic particles.

The content of the magnetic particles is desirably 20 mass % or more from the viewpoint of being able to orient the composite particles even in a relatively low magnetic field, where the total mass of the expanded graphite particle and expandable graphite particle in the base material is taken as 100 mass %. Further, from the viewpoint of cost reduction and weight reduction, the content of the magnetic particles is desirably 130 mass % or less, more preferably 100 mass % or less, and even more preferably 80 mass % or less. In the urethane foam molded body of the disclosure, since the first composite particle containing the expanded graphite particle with high thermal conductivity coefficient is included, the thermal conductivity does not easily decrease even if the content of the magnetic particles is reduced.

In the first composite particle and the second composite particle, the binder that adheres the core particles and the magnetic particles may be appropriately selected considering adhesiveness, impact on foam molding, and other factors. Water-soluble polymers are preferable because they have little impact on foam molding and are environmentally friendly. Examples include methyl cellulose, carboxymethyl cellulose, hydroxypropyl methyl cellulose, polyvinyl alcohol, starch, and the like. Among these, starch is preferable because it is relatively inexpensive and has high adhesiveness with excellent granulation properties. The binder for the first composite particle and the binder for the second composite particle may be the same or different.

Expanded graphite particles, expandable graphite particles, and magnetic particles have conductivity. Thus, when the first composite particle and the second composite particle are oriented in a connected manner, a conduction path is formed in the base material. For example, composite particles may be constituted by adhering insulating inorganic particles in addition to magnetic particles to the surface of core particles using a binder. By doing so, even when the composite particles are oriented, the electrical resistance between adjacent composite particles may be increased or conduction may be blocked. As a result, electrical insulation may be imparted to the urethane foam molded body. The urethane foam molded body of the disclosure, in which at least one of the first composite particle and the second composite particle has an insulating inorganic particle, is suitable for applications requiring electrical insulation, such as heat dissipation components in electronic appliances.

The insulating inorganic particle may be a particle of any insulating inorganic material. Among these, materials with relatively high thermal conductivity coefficient are desirable from the viewpoint of not hindering thermal conductivity between composite particles. For example, it is preferable that the thermal conductivity coefficient of the insulating inorganic particle is 5 W/m·K or more. Examples of insulating inorganic materials with a thermal conductivity coefficient of 5 W/m·K or more include aluminum hydroxide, aluminum oxide, magnesium hydroxide, magnesium oxide, talc, calcium carbonate, clay, mica, silica, and the like. These may be used alone or in combination of two or more types. Among these, talc and mica are preferable because they exhibit a flaky shape and have excellent coverage properties.

The insulating inorganic particles may be directly adhered to the surface of the core particles, or may be indirectly adhered through the magnetic particles. Further, the insulating inorganic particles may be adhered to only a portion of the surface of the core particles, or may be adhered to cover the entire surface. From the viewpoint of increasing the electrical resistance between composite particles and enhancing the electrical insulation of the urethane foam molded body, it is desirable that the insulating inorganic particles are arranged in the outermost layer of the composite particles. The binder for adhering the magnetic particles to the core particles and the binder for adhering the insulating inorganic particles may be the same or different.

The size of the insulating inorganic particles may be appropriately determined considering the adhesiveness to the core particles and magnetic particles, as well as the electrical insulation and thermal conductivity between composite particles. If the insulating inorganic particles are too large, the adhesiveness and thermal conductivity between composite particles decrease. For example, it is desirable that the particle diameter of the insulating inorganic particles is 1/100 or more and 1/10 or less of the particle diameter of the core particles. The shape of the insulating inorganic particles is not particularly limited. For example, in the case where the shape of the insulating inorganic particles is flat, the distance between adjacent core particles may be shortened compared to the case where they are spherical. Thus, it is less likely to hinder the thermal conductivity between adjacent composite particles. Further, due to the increased contact area, the insulating inorganic particles are less likely to peel off.

The insulating inorganic particles may be simply dispersed in the base material rather than as part of the composite particles, or they may constitute the composite particles and be further dispersed in the base material. The insulating inorganic particles dispersed in the base material may be the same as or different from the insulating inorganic particles added as constituent particles of the composite particles. Further, the insulating inorganic particles dispersed in the base material may be of one type or two or more types. For the insulating inorganic particles dispersed in the base material, those with relatively high thermal conductivity coefficient are also desirable, and the aforementioned aluminum hydroxide, aluminum oxide, magnesium hydroxide, magnesium oxide, talc, calcium carbonate, clay, mica, silica, etc. are suitable. When insulating inorganic particles are dispersed in the base material, the insulating inorganic particles enter between the composite particles, making it difficult for the composite particles to conduct with each other. Thus, the electrical insulation of the urethane foam molded body is improved. Further, in the case where the thermal conductivity coefficient of the insulating inorganic particles is relatively high, a transmission path of heat by the insulating inorganic particles is also formed in addition to the transmission path of heat by the composite particles. This further improves the thermal conductivity of the urethane foam molded body. Furthermore, in the case where the insulating inorganic particles have flame retardancy, the flame retardancy of the urethane foam molded body is improved.

### <Manufacturing Method of Urethane Foam Molded Body>

The manufacturing method of the urethane foam molded body of the disclosure is not particularly limited. As one preferred embodiment of the manufacturing method, the manufacturing method of the urethane foam molded body of the disclosure includes a composite particle manufacturing process, a mixed raw material manufacturing process, and a foam molding process. Each process is described below.

### [Composite Particle Manufacturing Process]

This process is a process of manufacturing composite particles by stirring granulation raw material having powder of particles that become the core, powder of magnetic particles, a binder, and water. Regarding the composite particles, the first composite particles having expanded graphite particles and the second composite particles having expandable graphite particles may be manufactured together or separately. Since expanded graphite powder and expandable graphite powder have similar specific gravity and do not have significant differences in granulation properties, the first composite particles and the second composite particles may be manufactured together, thereby improving productivity.

In the case of manufacturing two types of composite particles together, both expanded graphite powder and expandable graphite powder may be stirred with other raw materials such as water. In this case, considering granulation properties, it is preferable to minimize the difference between the average particle diameter of the expanded graphite powder and the average particle diameter of the expandable graphite powder. Further, it is preferable to set the blending amount of expanded graphite powder to 20 mass % or more and 80 mass % or less when the total mass of expanded graphite powder and expandable graphite powder is 100 mass %. On the other hand, in the case of manufacturing two types of composite particles separately, the first composite particles may be manufactured by stirring expanded graphite powder with other raw materials such as water, and the second composite particles may be manufactured by stirring expandable graphite powder with other raw materials such as water. The manufacturing of composite particles may be performed using a high-speed stirring type mixing granulator. The blending amounts of magnetic particle powder, binder, and water relative to the powder of particles that become the core may be appropriately adjusted considering granulation properties, magnetic field orientation of the composite particles, etc.

The blending amount of magnetic particle powder, considering the magnetic field orientation of the composite particles, is preferably 20 parts by mass or more per 100 parts by mass of the powder of particles that become the core. On the other hand, considering cost and weight reduction, it is preferable to limit blending amount of magnetic particle powder to 130 parts by mass or less, more preferably 100 parts by mass or less, and even more preferably 80 parts by mass or less. The blending amount of the binder, as a sufficient amount necessary for particle adhesion, is preferably 2 mass % or more when the total mass of the powder to be adhered is 100 mass %. On the other hand, if the binder becomes excessive, there is a risk that the composite particles may aggregate with each other. Thus, the blending amount of the binder is preferably 10 mass % or less, and more preferably 5 mass % or less. The binder may be solid or liquid. In the case of using water-soluble powder as the binder, it is preferable to add water after stirring the binder and other powder raw materials in advance. By doing so, particle aggregation may be suppressed.

In the case of adding insulating inorganic particles as constituent particles of the composite particles, insulating inorganic particle powder may be included in the granulation raw material. In the case of placing insulating inorganic particles at the outermost layer of the composite particles, this process may have a configuration including a first stirring process of stirring a first raw material having powder of particles that become the core, magnetic particle powder, binder, and water, and a second stirring process of further stirring by adding insulating inorganic particle powder to the stirred material of the first raw material.

### [Mixed Raw Material Manufacturing Process]

This process is a process of manufacturing a mixed raw material by mixing powder of composite particles (including first composite particles and second composite particles) manufactured in the previous process with foamed urethane resin raw material.

Regarding the foamed urethane resin raw material, as mentioned earlier, it may be prepared from raw materials such as polyol, polyisocyanate, catalyst, foaming agent, foam regulator, etc. In the urethane foam molded body of this disclosure, insulating inorganic particles may be dispersed in the base material separately from the composite particles. In the case of manufacturing a urethane foam molded body of this form, the powder of composite particles and the powder of insulating inorganic particles may be mixed with the foamed urethane resin raw material. The mixed raw material may be manufactured, for example, by mechanically stirring the powder of composite particles and the foamed urethane resin raw material using stirring blades or the like. Further, the powder of composite particles may be added to at least one of the two components of the foamed urethane resin raw material (polyol raw material, polyisocyanate raw material), and after preparing two types of raw materials, the two raw materials may be mixed to manufacture the mixed raw material.

### [Foam Molding Process]

This process is a process of injecting the mixed raw material manufactured in the previous process into a cavity of a foam mold, and foam molding while applying a magnetic field such that the magnetic flux density in the cavity becomes substantially uniform.

The magnetic field may be formed in a direction to orient the composite particles. For example, in the case of orienting the composite particles in a straight line, it is desirable to form the magnetic field lines in the cavity of the foam mold to be substantially parallel from one end of the cavity toward the other end. To form such a magnetic field, magnets may be placed near two surfaces at one end and the other end of the foam mold so as to sandwich the foam mold. Permanent magnets or electromagnets may be used as the magnets. By using an electromagnet, the magnetic field may be instantly switched on and off, making it easy to control the strength of the magnetic field. Thus, foam molding is easier to control. Further, it is desirable that the magnetic field lines constituting the magnetic field form a closed loop. In this way, leakage of magnetic field lines is suppressed, and a stable magnetic field may be formed in the cavity.

In this process, the magnetic field is formed such that the magnetic flux density in the cavity becomes substantially uniform. For example, it is preferable that the difference in magnetic flux density within the cavity is within ±10%. Within ±5%, and more preferably within ±3% is more suitable. By forming a uniform magnetic field in the cavity of the foam mold, the uneven distribution of composite particles may be suppressed, and a desired orientation state may be obtained. Further, foam molding may be performed at a magnetic flux density of 150 mT or more and 350 mT or less. In this way, the composite particles in the mixed raw material may be reliably oriented. It is desirable that the magnetic field is applied while the viscosity of the foamed urethane resin raw material is relatively low. If the magnetic field is applied when the foamed urethane resin raw material has thickened and the foam molding has been completed to some extent, it is difficult to obtain the desired thermal conductivity because the composite particles are difficult to orient. It is noted that it is not necessary to apply the magnetic field throughout the entire time of foam molding.

After the foam molding is completed in this process, the urethane foam molded body of the disclosure is obtained by demolding. At this time, depending on the method of foam molding, a skin layer may be formed on at least one of one end and the other end of the urethane foam molded body. The skin layer may be removed depending on the application (although it is not necessary to remove it).

### EXAMPLES

Next, the disclosure is described more specifically by presenting examples.

### <Manufacturing of Composite Particle>

First, eight types of composite particles A to H were manufactured as follows (composite particle manufacturing process). For composite particles B to G, both expanded graphite powder and expandable graphite powder were stirred together to manufacture two types of first and second composite particles at once.

### [Composite Particle A]

Granulation raw material including expandable graphite powder, stainless steel powder, starch powder, talc powder, and water were stirred to manufacture composite particle A as the second composite particle. First, expandable graphite powder, stainless steel powder, and starch powder were placed in a container of a high-speed stirring type mixing granulator and mixed by blade stirring, then water was added and mixed for 1 minute. Next, talc powder was added and mixed for another 4 minutes. The stirring speed was set at 400 rpm. The obtained powder was dried to form the powder of composite particle A. Details of the materials used are summarized in (a) to (d) below, and the blending amounts are shown in Table 1 below (the same applies to the following composite particles B to H).

### [Composite Particles B to G]

Composite particles B to G were manufactured by the same method as the manufacturing method of composite particle A, except that expanded graphite powder was added as a granulation raw material. Composite particles B to G were manufactured by changing the blending ratio of expanded graphite powder and expandable graphite powder, and composite particles B to G include both first composite particles and second composite particles.

### [Composite Particle H]

Composite particle H was manufactured as the first composite particle by the same method as the manufacturing method of composite particle A, except that expanded graphite powder was used instead of expandable graphite powder.

### (a) Core Particle

Expandable graphite powder: “SYZR502FP” manufactured by Shijiazhuang Aidite Trading Co., Ltd., particle size 300 μm or more: 80% or more.

Expanded graphite powder: “AED-01” manufactured by Fuji Graphite Industries Co., Ltd., purity 99% or more, particle size 1000 μm or more: 80% or more.

### (b) Magnetic Particle

Stainless steel powder: “AKT” manufactured by Mitsubishi Steel MFG. Co., Ltd., average particle diameter 8.5 to 13.0 μm.

### (c) Binder

Starch powder: “Instant Tender Jel C” manufactured by Japan Corn Starch Co., Ltd.

### (d) Insulating Inorganic Particle

Talc powder: “Micro Ace (registered trademark) K-1” manufactured by Nippon Talc Co., Ltd., average particle diameter 8 μm.

TABLE 1

| | | | | B | C | D | E | F | G | |
|---|---|---|---|---|---|---|---|---|---|---|
| | | | A | First/ | First/ | First/ | First/ | First/ | First/ | H |
| Composite particle | | | Second | Second | Second | Second | Second | Second | Second | First |
| Granulation raw | Core particle | Expandable graphite powder | 1000 | 900 | 700 | 500 | 400 | 300 | 100 | — |
| material [g] | | Expanded graphite powder | — | 100 | 300 | 500 | 600 | 700 | 900 | 1000 |
| | Magnetic particle | Stainless steel powder | 600 | 600 | 600 | 600 | 600 | 600 | 600 | 600 |
| | Binder | Starch powder | 100 | 100 | 100 | 100 | 100 | 100 | 100 | 100 |
| | Insulating inorganic | Talc powder | 400 | 400 | 400 | 400 | 400 | 400 | 400 | 400 |
| | particle | | | | | | | | | |

| | Water | 400 | 400 | 400 | 400 | 400 | 400 | 400 | 400 |
|---|---|---|---|---|---|---|---|---|---|
| Blending amount of expanded graphite powder in the core particle | | 0 | 10 | 30 | 50 | 60 | 70 | 90 | 100 |
| powder [mass %] | | | | | | | | | |
| Content of magnetic particles relative to core particles [mass %] | | 60 | 60 | 60 | 60 | 60 | 60 | 60 | 60 |
| Urethane foam molded body | | A | B | C | D | E | F | G | H |
| Content of composite particles [volume %] | | 10 | 10 | 10 | 10 | 10 | 10 | 10 | 10 |
| Content of expanded graphite particles^{※1}[mass %] | | 0 | 10 | 30 | 50 | 60 | 70 | 90 | 100 |
| Evaluation result | Thermal conductivity [W/m · K] | 0.60 | 0.62 | 0.65 | 0.67 | 0.70 | 0.72 | 0.75 | 0.75 |
| | Flame rotardancy (UL94 standard) | V-0 | V-0 | V-0 | V-0 | V-0 | V-0 | V-2 | V-2 |

^{※1}The total mass of expanded graphite particles and expandable graphite particles is taken as 100 mass %

### <Manufacturing of Urethane Foam Molded Body>

Using the manufactured composite particles A to H, urethane foam molded bodies were manufactured. First, 100 parts by mass of polyether polyol (manufactured by Sumika Covestro Urethane Co., Ltd., “SBU (registered trademark) Polyol 0248”), 2 parts by mass of diethylene glycol as a chain extender (manufactured by Mitsubishi Chemical Corporation), 2 parts by mass of water as a foaming agent, 1.5 parts by mass of tetraethylenediamine-based catalyst (manufactured by Kao Corporation, “KAOLIZER (registered trademark) No. 31”), and 0.5 parts by mass of silicone-based foam regulator (manufactured by Toray Dow Corning Co., Ltd., “SZ-1333”) were mixed to prepare a polyol raw material. Further, a modified diphenylmethane diisocyanate (MDI) was prepared as a polyisocyanate raw material. The modified MDI was manufactured by mixing polyether polyol (same as above) and 4,4′-diphenylmethane diisocyanate (manufactured by Tosoh Corporation, “MILLIONATE MT”) to achieve an isocyanate (NCO) content of 70 mass %, and reacting at 100° C. for 180 minutes under nitrogen purge. Next, 80 parts by mass of composite particles and 60 parts by mass of aluminum hydroxide powder (manufactured by Nippon Light Metal Co., Ltd., “SB93”) as an insulating inorganic particle were added and mixed with 100 parts by mass of the polyol raw material to prepare a premix polyol. Subsequently, 100 parts by mass of the premix polyol and 10 parts by mass of the polyisocyanate raw material (modified MDI) were mixed to form a mixed raw material (mixed raw material manufacturing process).

Then, the mixed raw material was injected into an aluminum foam mold (with a cavity in the shape of a rectangular parallelepiped measuring 130 mm in length×130 mm in width×5 mm in thickness), and the foam mold was sealed. The foam mold was then placed in a magnetic induction foam molding device to perform foam molding. In the cavity of the foam mold, a uniform magnetic field was formed by substantially parallel magnetic field lines directed from the upper side toward the lower side. The magnetic flux density in the cavity was 200 mT, with the difference in magnetic flux density within the cavity being within +3%. The foam molding was performed with the magnetic field applied for the first 2 minutes, followed by approximately 5 minutes without the magnetic field (foam molding process). After the foam molding was completed, the molded body was removed from the mold to obtain a urethane foam molded body. The obtained urethane foam molded bodies were designated as urethane foam molded bodies A to H corresponding to the types of composite particles used. The content of composite particles in urethane foam molded bodies A to H was 10 volume % when the volume of the urethane foam molded body was taken as 100 volume %. Urethane foam molded bodies C to F are included in the concept of the urethane foam molded body of this disclosure.

### <Evaluation of Urethane Foam Molded Body>

The thermal conductivity and flame retardancy of the manufactured urethane foam molded bodies were evaluated. The evaluation results of thermal conductivity and flame retardancy are summarized in Table 1 above. The evaluation methods are as follows.

### [Thermal Conductivity]

The thermal conductivity coefficient of the urethane foam molded body was measured using “HC-110” manufactured by EKO Instruments Co., Ltd. in accordance with the heat flow meter method of JIS A 1412-2:1999.

### [Flame Retardancy]

A vertical burning test according to UL94 standard was conducted. In the vertical burning test, a flame from a gas burner was applied to the lower end of a vertically held sample for 10 seconds, and the sample was judged to be V-O level if it satisfied all of the following five criteria: (1) The sample does not burn for more than 10 seconds in either of the two flame applications. (2) The total burning time for two flame applications each to five samples does not exceed 50 seconds. (3) No sample burns up to the position of the fixing clamp. (4) No sample drips burning particles that ignite the cotton placed below the sample. (5) No sample continues to glow for more than 30 seconds after the second flame application.

As shown in Table 1, the urethane foam molded bodies C to F have composite particles C to F that contain both the first composite particles and the second composite particles, and the content of expanded graphite particles is 20 mass % or more and 80 mass % or less when the total mass of expanded graphite particles and expandable graphite particles is taken as 100 mass %. Thus, the thermal conductivity coefficient of urethane foam molded bodies C to Fis 0.65 W/m·K or more, and the flame retardancy is V-0, confirming that urethane foam molded bodies C to F satisfy both thermal conductivity and flame retardancy. In contrast, urethane foam molded body A using composite particle A containing only second composite particles and urethane foam molded body B with a low content of expanded graphite particles satisfied flame retardancy but resulted in inferior thermal conductivity. Further, urethane foam molded body H using composite particle H containing only first composite particles and urethane foam molded body G with a high content of expanded graphite particles satisfied thermal conductivity but resulted in inferior flame retardancy.

### INDUSTRIAL APPLICABILITY

The urethane foam molded body of the disclosure is suitable as a soundproofing material used for vehicle parts such as inverters, motors, and gearboxes of electric powertrains, cylinder heads and cylinder head covers of engines, and electronic appliances such as personal computers.

What is claimed is:

1. A urethane foam molded body, comprising:
a base material made of polyurethane foam, and composite particles oriented and contained in the base material,
wherein the composite particles comprise:
a first composite particle having an expanded graphite particle and a magnetic particle adhered to a surface of the expanded graphite particle by a binder; and
a second composite particle having an expandable graphite particle and a magnetic particle adhered to a surface of the expandable graphite particle by a binder, and
when a total mass of the expanded graphite particle and the expandable graphite particle in the base material is 100 mass %, a content of the expanded graphite particle is 20 mass % or more and 80 mass % or less.

2. The urethane foam molded body according to claim 1, wherein the expanded graphite particle has an average particle diameter of 100 μm or more and 3000 μm or less.

3. The urethane foam molded body according to claim 1, wherein the expanded graphite particle has a purity of 99% or more.

4. The urethane foam molded body according to claim 1, wherein the expandable graphite particle has an average particle diameter of 100 μm or more and 3000 μm or less.

5. The urethane foam molded body according to claim 1, wherein the composite particles have a content of 5 volume % or more and 50 volume % or less when a volume of urethane foam molded body is 100 volume %.

6. The urethane foam molded body according to claim 1, wherein the binder constituting the first composite particle and the second composite particle is a water-soluble polymer.

7. The urethane foam molded body according to claim 6, wherein the water-soluble polymer is one or more selected from methyl cellulose, carboxymethyl cellulose, hydroxypropyl methyl cellulose, polyvinyl alcohol, and starch.

8. The urethane foam molded body according to claim 1, wherein the magnetic particle constituting the first composite particle and the second composite particle has a content of 20 mass % or more and 80 mass % or less when a total mass of the expanded graphite particle and the expandable graphite particle in the base material is 100 mass %.

9. The urethane foam molded body according to claim 1, wherein the magnetic particle constituting the first composite particle and the second composite particle has one or more selected from an iron particle and an iron-based alloy particle.

10. The urethane foam molded body according to claim 1, wherein at least one of the first composite particle and the second composite particle has an insulating inorganic particle adhered to a surface of the expanded graphite particle or the expandable graphite particle by a binder.

11. The urethane foam molded body according to claim 10, wherein the insulating inorganic particle has one or more selected from aluminum hydroxide, aluminum oxide, magnesium hydroxide, magnesium oxide, talc, calcium carbonate, clay, mica, and silica.
